(19) United States
(12) Patent Application Publication
(10) Pub. No.: US 2023/0314237 A1
(43) Pub. Date: Oct. 5, 2023

(54) COOKING ACCESSORY AND METHOD OF USE

(71) Applicant: June Life, Inc., San Francisco, CA (US)

(72) Inventors: Nikhil Bhogal, San Francisco, CA (US); Nicholas Beyrer, San Francisco, CA (US); Mathias Watson Schmidt, San Francisco, CA (US)

(21) Appl. No.: 17/700,740

(22) Filed: Mar. 22, 2022

(51) Int. Cl. G01K 1/024; G01K 1/14

(52) U.S. Cl. CPC G01K 1/146; G01K 1/024; G01K 1/08; G01K 2207/06

(57) ABSTRACT

A cooking system, including: a cooking accessory, optionally one or more auxiliary components, optionally one or more external systems, and/or any other suitable components. The cooking accessory can include: a housing, a temperature probe, a communication module, a power source, a user interface, one or more connectors, optionally a motion sensor, optionally an external retention mechanism, a processing system, and/or any other suitable components.

### TECHNICAL FIELD

This invention relates generally to the cooking field, and more specifically to a new and useful cooking accessory in the cooking field.

### BRIEF DESCRIPTION OF THE FIGURES

FIG. 1 is a schematic representation of a variation of the cooking accessory.

FIG. 2 is a schematic representation of the housing.

FIG. 3 is a schematic representation of the probe retention mechanism.

FIG. 4 is an exploded view of the display.

FIG. 5 is an illustrative example of rendered information on the display.

FIG. 6 is a cross sectional view of the head.

FIG. 7 is a schematic representation of battery placement.

FIGS. 8A-8B are schematic representations of connectors.

FIG. 9 is an illustrative example of using the cooking accessory to determine the internal temperature of a food.

FIG. 10 is a schematic representation of auxiliary components connected to the cooking accessory.

FIG. 11 is an illustrative example of using the cooking accessory with a removable probe and a cooking appliance.

FIG. 12 is an illustrative example of wirelessly connecting the cooking accessory to a cooking appliance and a user device.

FIG. 13 is an illustrative example of determining a temperature estimate based on a model.

FIG. 14 is a schematic representation of a variant of the cooking accessory.

FIG. 15 is a schematic representation of a variant of cooking system operation.

FIG. 16 is an illustrative example of estimating a time until cooking completion using an example of a model.

FIG. 17 is an illustrative example of using an auxiliary component with the cooking accessory.

FIG. 18 is an illustrative example of an example of the cooking accessory with multiple temperature sensors.

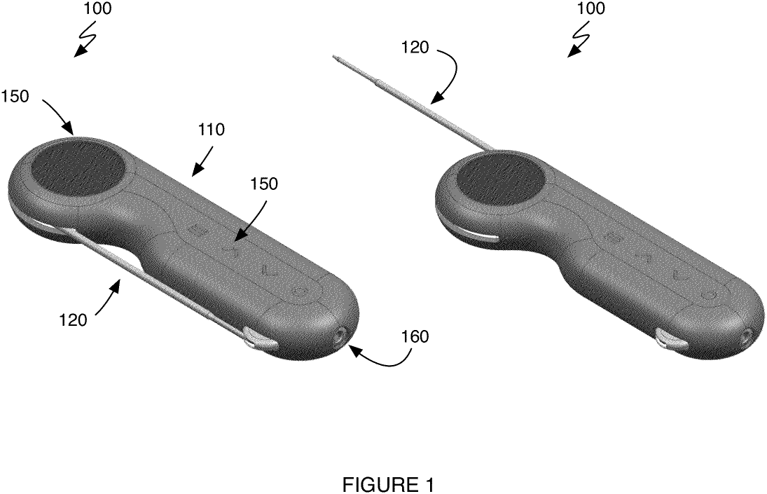

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1 Overview

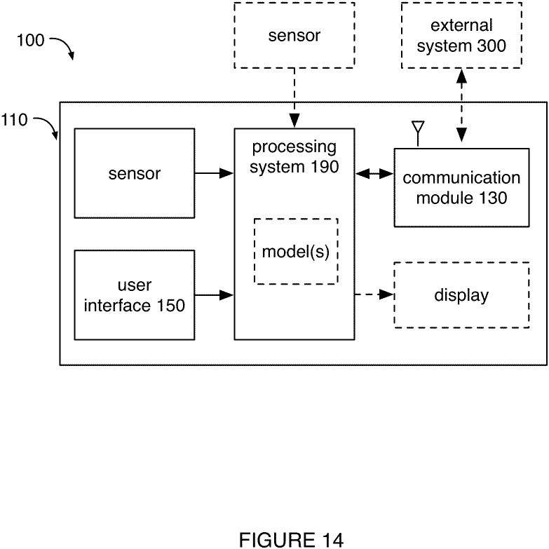

The cooking system can include: a cooking accessory 100, optionally one or more auxiliary components 200, optionally one or more external systems 300, and/or any other suitable components. The cooking accessory 100 can include: a housing 110, a temperature probe 120, a communication module 130, a power source 140, a user interface 150, one or more connectors 160, a motion sensor 170, optionally an external retention mechanism 180, a processing system 190, and/or any other suitable components; example shown in FIG. 14.

The cooking accessory 100 can be used with an auxiliary component 200 (e.g., an infrared auxiliary component, a removable probe, etc.), an external system 300 (e.g., a user device, a cooking appliance, etc.), and/or any other suitable system. The cooking accessory 100 can be used: to measure a temperature of an object, to provide notifications to a user, to execute one or more models based on sensor measurements (e.g., to estimate time to cooking completion, to detect cooking completion, to identify food, to determine food thickness, etc.), and/or otherwise used.

### 2 Benefits

The cooking system can confer several benefits over conventional systems.

First, variants of the cooking system can provide a facile user experience. For example, the display can be arranged in the head (e.g., over the rotary axis of the probe), such that the user can securely grip the handle without occluding the display. In another example, the thermometer can be wireless and portable. For example, the thermometer can be a wirelessly-connected instant-read thermometer, and have an onboard communication module (e.g., wireless communication module; lack an external wire connecting the sensor to a data hub) and temperature sensor (e.g., lack an external wire connecting the sensor to the thermometer body).

Second, variants of the cooking system can integrate with a cooking appliance (e.g., oven, grill, smoker, etc.). In these variants, the cooking accessory 100 can receive food parameters (e.g., food identifiers, preferred doneness, etc.), expected measurement values (e.g., expected internal temperature based on estimated cooking progress, etc.), and/or other information from the cooking appliance, and selectively: interpret sampled measurements, execute operation modes, execute models, and/or otherwise selectively operate based on the received food parameters. In these variants, the cooking accessory 100 can additionally and/or alternatively control cooking appliance operation, such as by controlling cooking element operation (e.g., heating elements, fans, humidity control, smoke control, etc.).

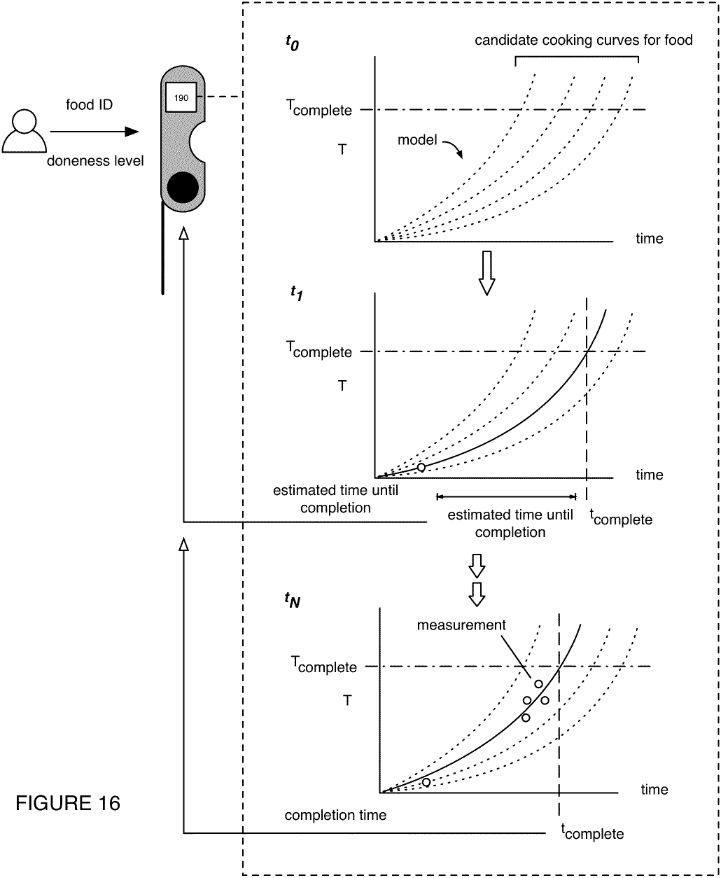

Third, variants of the cooking system can be used with a set of models (e.g., machine learning models, classical models, etc.), which can be executed onboard or remotely from the cooking accessory 100. This can enable the cooking accessory 100 to generate more intelligent notifications, generate richer interpretations of the sensor measurements, and/or confer other additional functionalities. For example, the cooking accessory 100 can: automatically estimate a time to cooking completion (example shown in FIG. 16), automatically determine that the food is done cooking, automatically identify the food, automatically infer food parameters (e.g., food thickness), generate more accurate temperature estimates for the food, and/or provide other additional functionalities.

Fourth, variants of the cooking accessory 100 can be used with one or more auxiliary components (e.g., infrared sensor, removable probe, camera, etc.) that are operably connected to the cooking accessory (e.g., via one or more data connectors). This can extend the cooking accessory’s sensing and/or output capabilities, such as by enabling the cooking accessory 100 to function as an all-in-one instant-read, leave-in, and infrared thermometer, thereby eliminating the need for multiple thermometers.

However, the systems and/or method can confer any suitable set of benefits.

### 3 System

The cooking system can include: a cooking accessory 100, optionally one or more auxiliary components 200, optionally one or more external systems 300, and/or any other suitable components. The cooking accessory 100 can include: a housing 110, a temperature probe 120, a communication module 130, a power source 140, a user interface 150, one or more connectors 160, optionally a motion sensor 170, optionally an external retention mechanism 180, a processing system 190, and/or any other suitable components.

The cooking accessory 100 functions to determine sensor measurements for an object. The cooking accessory is preferably an instant-read thermometer (e.g., hard probe), but can additionally and/or alternatively be a continuous-read thermometer (e.g., a wired probe), a contact thermometer (e.g., probe), a contactless thermometer (e.g., infrared thermometer) and/or any other suitable thermometer. Sensor measurements include temperature (e.g., external object temperature, internal object temperature, ambient temperature, etc.), thickness, pressure, proximity, sound, humidity, visual appearance, hardness, texture, and/or any other suitable sensor measurement. The object is preferably food (e.g., meat, soup, candy, baked goods, etc.), but can additionally and/or alternatively be a human body, an animal body, matter (e.g., air, water, soil, substance, etc.), and/or any other suitable object.

The cooking accessory 100 is preferably a handheld accessory, but can alternatively be a desktop accessory or have any other form factor. The cooking accessory 100 can have a length (e.g., in the closed state, but alternatively the open state) of less than: 15 inches, 12 inches, 10 inches, 8 inches, 6 inches, 4 inches, 2 inches, 1 inch, a range therebetween, more than any one of those values, and/or any other suitable length. The cooking accessory 100 can have a width of less than: 5 inches, 3 inches, 2 inches, 1 inch, any range therebetween, more than any one of those values, and/or any other suitable width. The cooking accessory 100 can have a weight (e.g., with or without an attached auxiliary component) of less than 5 ounces, 4 ounces, 3 ounces, 2 ounces, 1 ounce, any range therebetween, more than any one of those values, and/or any other suitable weight. However, the cooking accessory 100 can have any other suitable packaging parameters.

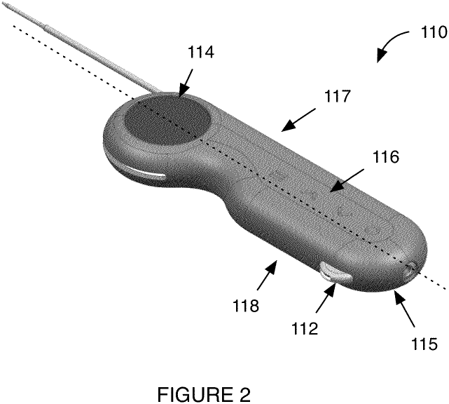

The housing 110 functions to enclose interior components of the cooking accessory 100. The housing 110 can be: long, skinny, round, pistol grip shaped, separatable, and/or have any other suitable form factor. The housing 110 can define a longitudinal axis (e.g., extending head 114 to base 115), a lateral axis (e.g., running perpendicular to the longitudinal axis), and/or any other suitable dimension axis. The housing 110 can define a head 114 located at a first end of the housing, a base 115 opposing the head 114 (e.g., located at a second end of the housing), a handle 116 extending between the head 114 and the base 115, a back 117 extending between the first and second end (e.g., substantially parallel to the longitudinal axis; cooperatively formed by the head 114 and the handle 116; etc.), a front 118 opposing the back 117 (e.g., across the width of the handle 116), and/or any other suitable region; example shown in FIG. 2.

The head 114 is preferably round, but can additionally and/or alternatively be square, triangular, hexagonal, prismatic, and/or any other suitable geometry. In variants where the temperature probe is mounted within the head 114, the head 114 can define an arcuate groove extending along the sidewall of the head 114, which can allow the temperature probe to rotate relative to the head 114. The handle 116 can be straight-sided, profiled, curved, grooved, shaped like a handle/knob, rounded, rectangular, tapered/un-tapered, uniform thickness, variable thickness, and/or any other suitable geometry.

The housing 110 is preferably constructed to be thermally insulative, but can alternatively be thermally conductive. The housing 110 can be made of polymer (e.g., plastic, thermoplastic, silicone, etc.), glass, metal (e.g., aluminum, stainless steel, copper, etc.), ceramic, a combination thereof, and/or any other suitable material composition. The housing 110 can be coated, but can alternatively be uncoated. The housing 110 can be fully water-resistant, fully waterproof, partially water-resistant, partially waterproof, not resistant to water, and/or otherwise related to water.

In an illustrative example, the housing has a water-resistant wet zone and a dry zone. The wet zone can be located in the head 114, in the handle 116, and/or in any other region. The wet zone can be cleanable to remove any food, contaminants, debris, oil, and/or any other matter. The dry zone can be located in the handle 116 and partially in the head 114, entirely in the handle 116, entirely in the head 114, and/or in any other region. For example, the dry zone can extend to above the rotary hub 122 where the display is located, such that the display is located within the dry zone (e.g., protected by an acrylic lens sealed by pressure sensitive adhesive, etc.). The dry zone can be defined by a thermoplastic elastomer lining acting as a continuous seal around the perimeter of the housing, except at openings near connectors to accommodate for plug-ins. In variants where the cooking accessory includes open connector ports, the housing can include a seal encapsulating each connector opening that contacts the thermoplastic elastomer lining. However, the housing 110 can be otherwise constructed for water-resistance.

The housing 110 preferably includes an ergonomic groove feature, but can alternatively not include an ergonomic groove feature. The ergonomic groove feature is preferably located on the handle 116 front proximal the head 114 (e.g., adjacent to the head 114, along the handle 116 below the head 114, etc.) and/or along the side of the handle 116 proximal the temperature probe in the closed position (e.g., define a gap between the closed temperature probe and the handle 116 surface), but can alternatively be located at the bottom side of the handle 116, and/or otherwise located. The ergonomic groove feature can be: a divot, a recess, and/or any other suitable feature. The ergonomic groove feature can have clearance between the groove nadir and the temperature probe 120 (e.g., in closed configuration) of ¼”, ½”, 1″, 2″, 3″, any/or any other suitable clearance.

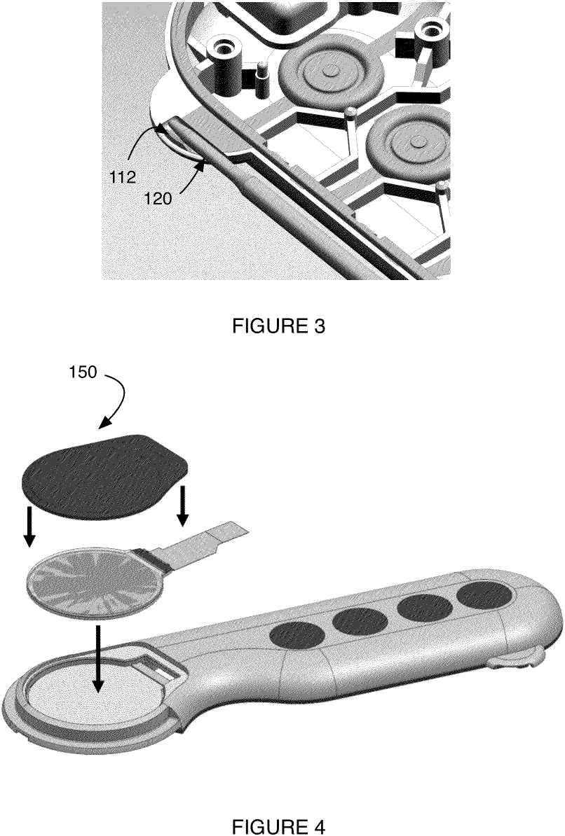

The housing 110 preferably includes a probe retention mechanism 112 (example shown in FIG. 3), but can alternatively not include a probe retention mechanism 112. The probe retention mechanism 112 functions to retain the temperature probe 120 relative to the housing 110. The probe retention mechanism 112 can be a rigid component or feature, such as a groove, a ledge, a cavity, a retention pin or other feature, a magnetic element, an external clip, a pin, and/or any other suitable probe retention mechanism 112. The probe retention mechanism 112 is preferably located at the bottom side of the handle 116, but can alternatively be otherwise located. However, the housing 110 can be otherwise configured.

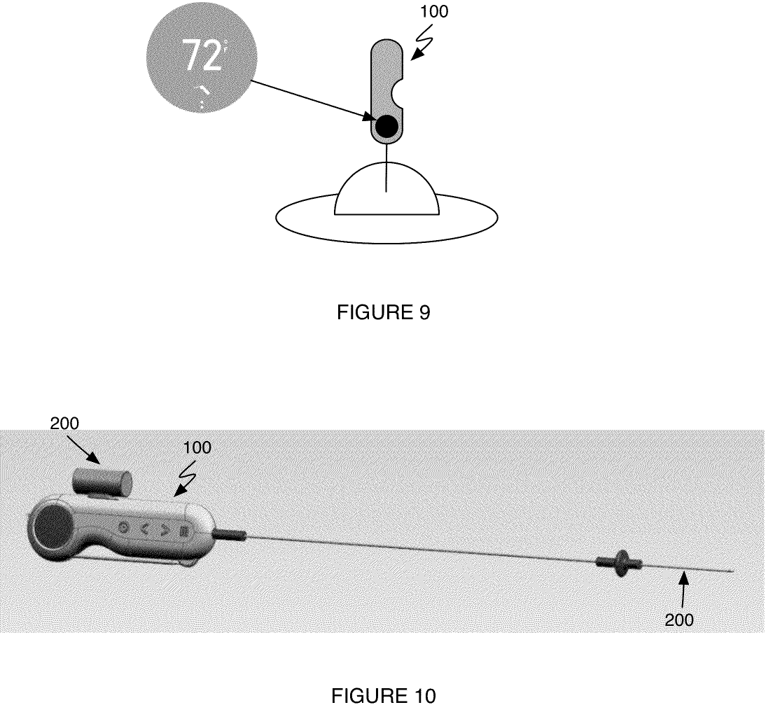

The temperature probe 120 functions to measure one or more temperatures of an object (example shown in FIG. 9). The cooking accessory 100 can include one temperature probe 120, multiple temperature probes 120, and/or any other suitable number of temperature probes. The temperature probe 120 preferably measures an internal temperature of an object, but can additionally and/or alternatively measure an external temperature of an object. The temperature probe 120 is preferably operable between a closed and/or retracted position and an open and/or extended position, but can alternatively be static (e.g., not actuatable) and/or operable in any other suitable position. The temperature probe 120 is preferably mounted to the housing 110, but can alternatively be removably connected to the housing 110, and/or otherwise coupled to the housing. The temperature probe preferably extends from the housing, but can be fully enclosed within the housing. The temperature probe is preferably partially enclosed within the housing (e.g., at all times); alternatively, the temperature probe can be mounted to an external surface of the housing or be separate from the housing. The temperature probe preferably lacks an external wire (e.g., is connected to the processing system or other components via internal wires only), but can alternatively include an external wire (e.g., be connected to the processing system and/or housing via a wire external the housing). The temperature probe 120 is preferably mounted to the housing 110 using a probe actuation mechanism, but can alternatively use any other suitable mechanism. The temperature probe 120 can be manually actuated, automatically actuated, passively actuated, passively actuated, and/or otherwise actuated. The temperature probe can be retractable, wrapped about the housing, rotatable relative to the housing, slidable relative to the housing, and/or otherwise actuatable relative to the housing. The probe actuation mechanism is preferably a rotary hub 122 (probe hub), but can alternatively be a ratcheting system, a sliding system, and/or any other suitable probe actuation mechanism.

The rotary hub 122 (probe hub) functions to rotatably mount the temperature probe 120 to the housing 110. The rotary hub 122 is preferably encapsulated within the housing 110 (e.g., in the head 114, in the wet zone, etc.), but can alternatively be external to the housing 110. The rotary hub 122 is preferably mounted to the housing 110 about a rotational axis, but can alternatively be mounted to the housing 110 about multiple rotational axes, and/or otherwise mounted. The rotary hub 122 is preferably statically mounted to an end of the temperature probe 120, but can alternatively be removably mounted to an end of the temperature probe 120, and/or otherwise mounted. The rotary hub 122 can optionally include: an encoder, a magnet, a hall effect sensor, other arcuate position sensors, and/or any other suitable components. In a specific example, the rotary hub 122 includes a magnet (e.g., mounted to the rotary hub 122) while the housing includes a hall effect sensor 124 aligned with the magnet when the temperature probe is in a predetermined position (e.g., the closed position, the open position, etc.). The rotary hub 122 is preferably rotatably mounted to the head 114 of the housing 110 about a rotational axis, wherein one end of the temperature probe 120 is statically mounted to the rotary hub 122. This can enable the temperature probe 120 to rotate relative to the housing 110 within a predetermined angle range (e.g., between 0 and 90 degrees, between 0 and 180 degrees, between 0 and 270 degrees, etc.). However, the rotary hub 122 can be otherwise configured.

The temperature probe 120 can include: a probe body, a temperature sensor, and/or any other suitable component. The probe body functions to support the temperature sensors. The probe body is preferably thermally conductive, but can alternatively be thermally insulative. The probe body is preferably straight, but can alternatively be curved or have any other geometry. The probe body is preferably rigid, but can alternatively be flexible.

The first end of the probe body is preferably mounted to the probe actuation mechanism, but can alternatively be otherwise mounted to the probe actuation mechanism, and/or not mounted to the probe actuation mechanism. The first end of the probe body is preferably entrained within the housing 110, but can alternatively be external to the housing 110.

The second end of the probe body (e.g., probe tip) preferably supports (e.g., mounts) one or more temperature sensors. The temperature sensor can be: a thermistor (e.g., a glass thermistor), a thermocouple, a resistance thermometer, and/or any other suitable temperature sensor.

The temperature probe 120 preferably includes two temperature sensors, but can alternatively include a single temperature sensor, more than two temperature sensors (e.g., example shown in FIG. 18), and/or any other suitable number of temperature sensors. In variants, the cooking accessory 100 can include multiple temperature sensors to confer resilience to common user errors. Such variants can provide flexibility in user error resulting from improper temperature probe insertion, such as common errors associated with: the probe tip not touching the center of the object (e.g., food), the temperature probe 120 touching the walls of a container (e.g., grill tray), and/or any other additional challenges/common errors. By determining the lowest measured temperature between the multiple temperature sensors can achieve a more accurate temperature estimation of internal temperature of the object. Additionally or alternatively, food parameters can be inferred from the multiple (contemporaneous) temperature measurements. For example, the food thickness can be determined by identifying a subset of temperature sensors measuring the food, and calculating the food thickness based on the known positions of the temperature sensors (e.g., on the probe body). The subset of temperature sensors measuring the food can be determined by identifying temperature sensors measuring temperatures different from the ambient temperature; identifying temperature sensors on either side of a temperature sensor boundary (bounding temperature sensors), based on a sharp measured temperature gradient between the bounding temperature sensors; and/or otherwise determined. However, the temperature probe 120 can be otherwise configured.

The temperature probe 120 and/or each temperature sensor can have a measurement accuracy and/or measurement precision within: .1° F., .2° F., .5° F., 1° F., 1.5° F., 2° F., 10° F., more than 10° F., within any range bounded by any of the aforementioned values, and/or any other suitable measurement accuracy and/or measurement precision, and/or measurement unit.

Each temperature sensor can be: flush with the probe body, recessed from the probe body, protrude from the probe body, aligned along the probe body, inside the probe body, and/or otherwise arranged relative to the probe body. In an example, multiple temperature sensors are linearly aligned within the probe body (e.g., along the same side, along the longitudinal axis, etc.). In another example, multiple temperature sensors are located at different positions along the probe body length and arranged in a pattern (e.g., a spiral pattern, a zigzag pattern, etc.). However, multiple temperature sensors can be otherwise arranged. The separation distance between multiple temperature sensors can be: 1 mm, 5 mm, 10 mm, 15 mm, 20 mm, and/or any other suitable distance.

Temperature measurements are preferably contemporaneously (e.g., concurrently, within the same timeframe, etc.) sampled by the multiple temperature sensors, but can alternatively asynchronously sampled. In variants, a temperature estimate can be determined (e.g., by the processing system 190) based on the temperature measurements sampled by multiple temperature sensors, but can alternatively be based on one sampled temperature measurement by a temperature sensor (e.g., a timeseries of temperature measurements from the sensor), and/or otherwise determined. In an example, the temperature estimate is the lowest temperature measurement among the temperature measurements. In another example, the temperature estimate is the average temperature measurement among the temperature measurements. The temperature estimate and/or measurement is preferably numerical, but can alternatively be categorical. The temperature estimate and/or measurement is preferably continuous, but can alternatively be discrete.

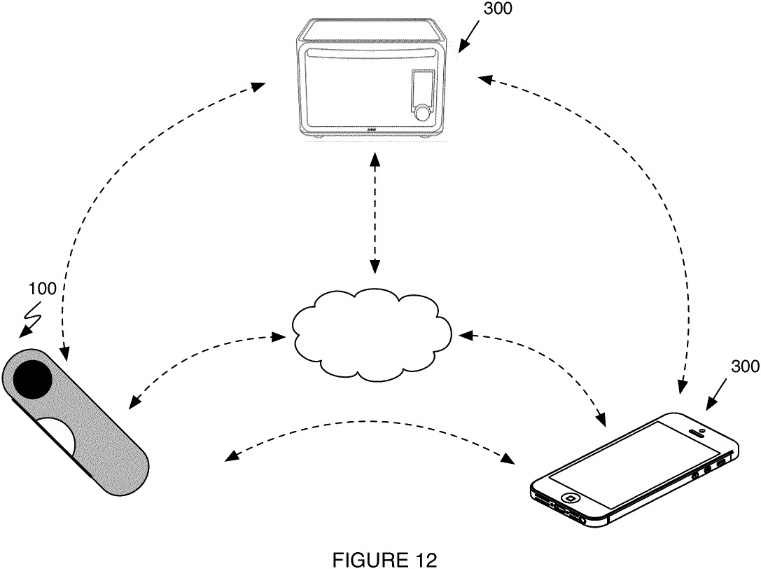

The communication module 130 functions to enable communication between the cooking accessory 100 and an external system 300 (e.g., transmit and/or receive data by the cooking accessory 100 to and/or from the external system 300); example shown in FIG. 12. The cooking accessory 100 can include one communication module 130, multiple communication modules 130 (e.g., same and/or different types), and/or any other suitable number of communication modules. The communication module 130 is preferably a wireless communication module (e.g., wireless module), but can additionally and/or alternatively be a wired communication module. The communication module 130 can be: Wi-Fi (e.g., WiFi module), Bluetooth (e.g., Bluetooth module; wherein the protocol can be Bluetooth classic, BLE, UWB, etc.), cellular, Zigbee, Z-wave, NFC, RF, mesh, radio, micro-USB, USB-A, USB-C, ethernet, and/or any other suitable communication module. The communication module 130 is preferably constructed with a chipset, an antenna, and a memory, but can alternatively be otherwise constructed. The communication module 130 is preferably part of the same chipset as the computing system (e.g., processing system), but can alternatively be separate. The communication module 130 is preferably located in the handle 116, but can alternatively be located in the head 114, external to the housing 110, and/or any other suitable location. The communication module 130 is preferably fully enclosed within the housing, but can alternatively be partially enclosed within the housing (e.g., with the antenna protruding out of the housing or connected to the ambient environment via a hole in the housing) or entirely external the housing.

In variants, the communication module 130 can be arranged with an antenna directed toward the front 118, such that when the handle 116 is grabbed by the hand of a user, the tip of the antenna is facing away from the palm and/or towards the fingertips. Such variants can prevent signal blocking of the communication module 130 by the palm. Alternatively, the antenna can be directed toward the base 115, directed toward the head 114, and/or in any other suitable direction.

The communication module 130 preferably stores wireless credentials (e.g., network name, password, cryptographic key, etc.; e.g., WiFi credentials, Bluetooth credentials, etc.), but can alternatively not store wireless credentials (e.g., wherein the processing system or other system can store the wireless credentials). The communication module 130 can connect to a local network and/or an external system 300 using the wireless credentials, but can alternatively otherwise connect to a local network and/or an external system 300. However, the communication module 130 can be otherwise configured.

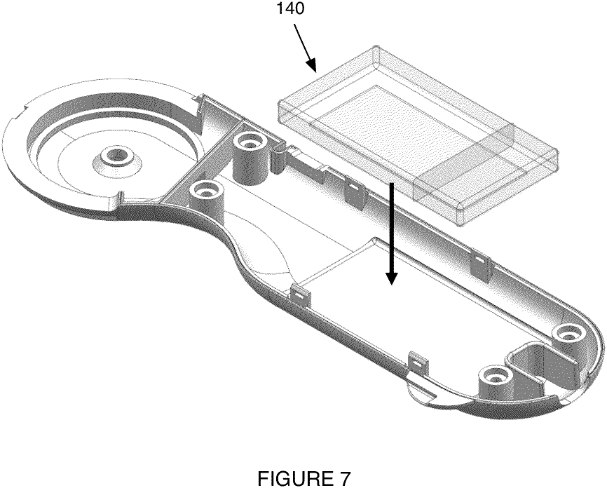

The power source 140 functions to power the cooking accessory 100 during operation. The power source 140 is preferably located in the handle 116 (example shown in FIG. 7), but can alternatively be located in the head 114, external to the housing 110, and/or any other suitable location. The power source 140 is preferably a rechargeable battery, but can alternatively be a non-rechargeable battery (e.g., a disposal battery), induction coil, RF charger, and/or any other suitable power source. The power source 140 is preferably a lithium-ion battery, but can alternatively be a nickel-cadmium battery, a nickel-metal-hydride battery, a lithium-ion polymer battery, and/or any other suitable rechargeable battery. The power source 140 is preferably charged via USB-C, but can alternatively be charged via USB, USB-A, Bluetooth, induction, and/or any other suitable power charging component. However, the power source 140 can be otherwise configured.

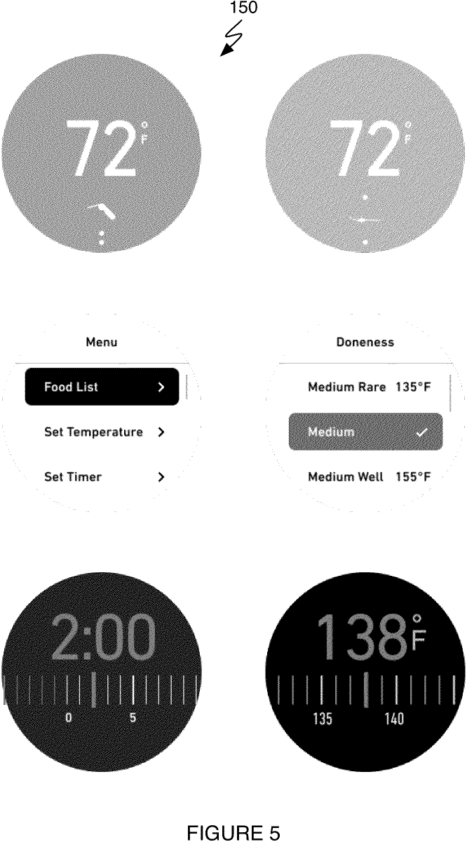

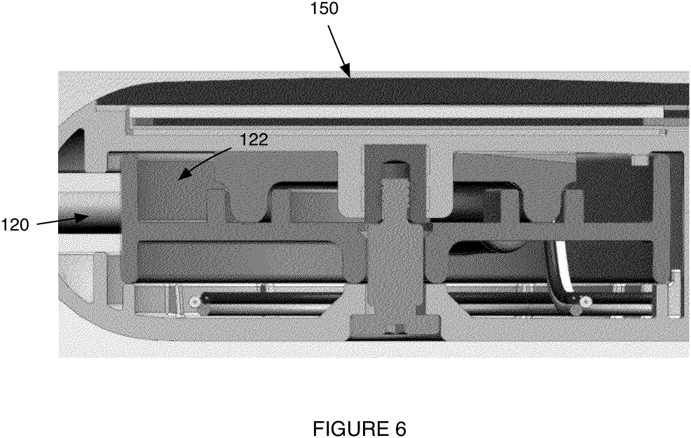

The user interface 150 functions to enable a user to interact with the cooking accessory 100. The user interface 150 can include one or more user outputs, one or more user inputs, include the communication module 130, and/or include any other component. Alternatively, the cooking system can exclude all or components of the user interface 150 (e.g., exclude a display, exclude a physical user input, etc.). One or more components of the user interface 150 can be mounted to the housing, to an external system, and/or to any other system. The user output is preferably a display (example shown in FIG. 4), but can additionally and/or alternatively be: a projector, a speaker, a printer, a plotter, a headphone, an auxiliary component, an external system (e.g., wherein the output data is transmitted to the external system via the wireless connection), and/or any other suitable user output. The display functions to display information from the temperature probe 120 and/or auxiliary component(s) 200 (e.g., removable probe, infrared auxiliary component, etc.). The information can be: a measurement value sampled by the cooking accessory 100, a menu, an auxiliary component indicator (e.g., an icon), a time elapsed, a time remaining, an analysis result, and/or any other suitable data (examples shown in FIG. 5). The menu can be: a food identifier, a target temperature, a timer, an external system identifier, and/or any other suitable information. The analysis result can be: whether a food is done cooking, time elapsed, estimated time remaining, measurement values over a time period (e.g., in a graph form, in a table form, etc.), measurement values aggregated over a time period (e.g., minimum value, maximum value, average value, median value, mode value, etc.), and/or any other suitable analysis. The cooking accessory 100 can have: one display, multiple displays, and/or any other suitable number of displays. The display is preferably located along the head 114, but can alternatively be located along the handle 116, and/or any other suitable location. More specifically, the display is preferably located in the dry zone of the head 114, but can alternatively be in the wet zone, and/or any other suitable location. The display is preferably aligned with the rotary hub 122 (example shown in FIG. 6), but can alternatively be offset the rotary hub 122, and/or otherwise located relative to the rotary hub 122. In an example, the display is coaxially aligned with the rotational axis of the rotary hub 122. In another example, the rotational axis of the rotary hub 122 intersects the display plane (e.g., wherein the rotary hub 112 can be coaxial with and/or offset from the display center). In another example, the rotary axis is orthogonal to the display plane. However, the display can be otherwise arranged relative to the rotary hub 122. The display is preferably round, but can additionally and/or alternatively be square, triangular, hexagonal, and/or have any other suitable geometry. The display is preferably a smartwatch display, but can alternatively be a segmented LCD, a segmented LED, and/or any other suitable display. The display is preferably tilted at a predetermined angle (e.g., less than 5 degrees, 5 degrees, 10 degrees, 15 degrees, 20 degrees, 25 degrees, 30 degrees, more than 30 degrees, any range or value therebetween, etc.) relative to the housing 110, but can alternatively be not tilted relative to the housing 110. The rendered information on the display can be statically and/or dynamically rotated based on motion sensor data sampled by a motion sensor 170, but can alternatively not be rotated. For example, the rendered information is oriented relative to the gravitational vector determined from measurements sampled by a motion sensor 170. However, the rendered information can be otherwise oriented.

The cooking accessory 100 can include: one user input, multiple user inputs, and/or any suitable number of user inputs. The user input is preferably buttons (e.g., up button, down button, select button, menu button, etc.), but can alternatively be a keyboard, a mouse, a touchscreen (e.g., overlaid over the display, located in another location, etc.), gesture control, a microphone, a camera, an auxiliary component, an external system, and/or any other suitable user input. The user input is preferably located along the handle 116, but can alternatively be located along the head 114, and/or any other suitable location. However, the user interface 150 can be otherwise configured.

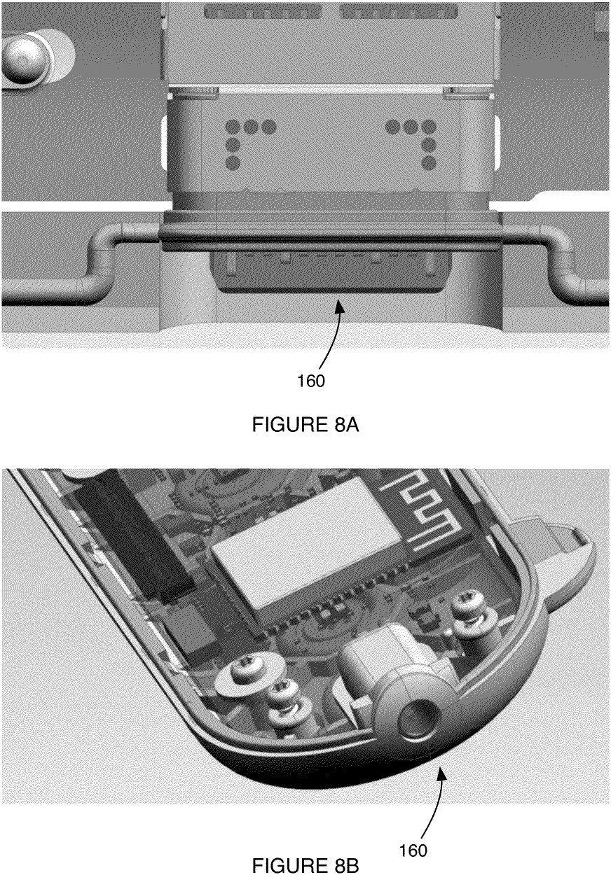

The connector 160 functions to connect an auxiliary component 200 to the cooking accessory 100. The connector 160 preferably removably connects the auxiliary component 200 and/or external system 300 to the cooking accessory 100, but can alternatively permanently connect the secondary component to the cooking accessory 100. The connector 160 can be: a mechanical connector, a data connector, a power connector, and/or any other suitable connector. The cooking accessory 100 can include one connector 160, multiple connectors 160 (e.g., 2, 3, etc.), and/or any other suitable number of connectors. The connector 160 can be: a USB-A port, a USB-C port (example shown in FIG. 8A), a micro-USB port, an auxiliary jack (example shown in FIG. 8B), and/or any other suitable connector. The connector 160 can be: a plug or socket connector, a crimp on connector, a soldered connector, a binding post, a screw terminal, a ring and spade connector, a blade connector, twist-on wire connector, alligator clip, and/or any other suitable connector. The connector 160 is preferably waterproof, but can alternatively be water-resistant or not resistant to water. The connector 160 can be located: along the back 117, along the base 115, in the head 114, and/or any other suitable location.

In a first variant, the connector 160 can include a power connector (e.g., a USB-C port). In examples, this can connect a charging cable to the power source 140 to charge the cooking accessory. Additionally or alternatively, the connector 160 can include a data connector (e.g., a USB-C port). In examples, this can connect an auxiliary component 200 (e.g., infrared auxiliary component) to the processing system 190, such that the cooking accessory can use (e.g., sample measurements using) the auxiliary component.

In a second variant, the connector 160 can include a data connector with an auxiliary jack. In examples this can connect a removable probe (e.g., tethered and/or wired temperature probe) to the processing system 190 and/or other component of the cooking accessory.

However, the connector 160 can be otherwise configured.

The motion sensor 170 functions to measure motion acceleration of the cooking accessory 100. The cooking accessory 100 can include: one motion sensor 170, multiple motion sensor 170, and/or any other suitable number of motion sensor. The motion sensor 170 can be: an IMU, an accelerometer, a gyroscope, a kinematic sensor, and/or any other suitable motion sensor. The motion sensor 170 is preferably located in the handle 116, but can alternatively be located in the head 114, external to the housing 100, and/or any other suitable location. However, the motion sensor 170 can be otherwise configured.

The cooking accessory can additionally or alternatively include one or more other sensors. Examples of other sensors that can be used include: pressure sensors, force sensors, humidity sensors, optical sensors, acoustic sensors, and/or any other sensor. The other sensors can be arranged in: the housing, the probe, and/or any other component.

The external retention mechanism 180 functions to retain the cooking accessory 100 relative to an external surface. The cooking accessory 100 can include: one external retention mechanism 180, multiple external retention mechanisms 180, and/or any suitable other number of retention systems. The external retention mechanism 180 is preferably a magnet, but can alternatively be a kickstand, a clip, and/or any other suitable retention mechanism. The magnet is preferably located in the handle 116 towards the center of the housing 110, but can alternatively be located elsewhere in the handle 116, in the head 114, external to the housing 110, and/or any other suitable location. The external surface can be: a surface with a magnetic field (e.g., typically external surface of a refrigerator and other cooking appliances), a surface in the kitchen (e.g., a kitchen countertop, a stovetop) and/or any other suitable surface. However, the external retention mechanism 180 can be otherwise configured.

The processing system 190 functions to control cooking accessory 100 operation and/or external system 300 operation. The processing system is preferably located in the handle 116, but can alternatively be in the head 114, external to the housing 110, and/or any other suitable location. The cooking accessory 100 can include one processing system 190, multiple processing systems 190, and/or any other suitable number of processing systems. The processing system 190 can include: one or more processors, a memory, and/or any other suitable component. The processing system 190 can be: uncooled, passively cooled (e.g., using the housing as a heatsink; by cooking channels defined by the housing; etc.), actively cooled, and/or otherwise cooled.

The processing system 190 can be configured to: store calibration information and/or calibrate the cooking accessory 100. For example, the processing system can store a temperature sensor signal (e.g., measured signal) in association with a temperature value. The temperature value can be inferred (e.g., from operation context), received from a user, and/or otherwise determined. In a first specific example, a user is instructed to insert the temperature probe into boiling water. The cooking accessory (e.g., processing system 190) can record the temperature sensor signal measured by the temperature probe, and store the temperature sensor signal in association with 100° C. In a second specific example, a user is instructed to insert the temperature probe into ice water. The cooking accessory (e.g., processing system 190) can record the temperature sensor signal measured by the temperature probe, and store the temperature sensor signal in association with o°C.

The processing system 190 can be configured to: select an operation mode and/or operate the cooking system according to the selected operation mode. The operation mode can be: a countertop mode (e.g., increase in temperature for a time period greater than a predetermined threshold), a handheld mode (e.g., increase in temperature for a time period less than a predetermined threshold), a sleep mode (e.g., consume less than a threshold amount of power, etc.), a wake mode (e.g., power the display, power the processing system 190, etc.), an infrared mode (e.g., detect an infrared auxiliary component plugged into the connector 160), a removable probe mode (e.g., detect a removable probe plugged into the connector 160), a charging mode (e.g., charge of the power source 140), and/or any other suitable operation mode. Different operation modes can be associated with different or the same onboard component, different or the same auxiliary components, different or the same displayed information, and/or have any other set of associations. The operation mode can be determined based on: a cooking accessory state, a condition satisfaction, a connected auxiliary component 200, a connected external system 300, selected by a user (e.g., from the menu; via the user interface; etc.), determined from a user instruction (e.g., derived from a user selection, received from an external system, etc.), and/or any otherwise based.

In a first variant, the processing system 190 can select different operation modes based on the cooking accessory state. The cooking accessory state can be determined based on: the temperature probe position, the acceleration of the motion sensor 170, and/or otherwise determined. In a first embodiment, the cooking accessory 100 state can be based on the temperature probe position. In a first specific example, the processing system 190 detects a sleep mode when the temperature probe 120 is in a closed position. In a second specific example, the processing system 190 detects a non-sleep mode when the temperature probe 120 is in a fully opened, partially opened, and/or non-closed position. In a second embodiment, the cooking accessory state can be based on the acceleration of the motion sensor 170. In a first specific example, the processing system 190 detects a sleep mode when an acceleration measured by the motion sensor is less than a threshold value for a predetermined time period. In a second specific example, the processing system 190 detects a non-sleep mode when an acceleration measured by the motion sensor is greater than a threshold value for a predetermined time period. However, the cooking accessory state and/or operation mode can be otherwise determined.

In a second variant, the processing system 190 can select different operation modes based on a condition satisfaction. The condition can be: timer expiration, whether the external retention mechanism 180 is engaged and/or not engaged, whether the probe retention mechanism 112 is engaged and/or not engaged, a voice command user input, whether a temperature higher than ambient is detected, and/or any other suitable condition.

In a third variant, the processing system 190 can select different operation modes based on which auxiliary component 200 is connected. In a first example, the processing system 190 receives a connector identifier for an auxiliary component 200 connected to the connector 160 and determines an operation mode based on the connector identifier. In an illustrative example, the processing system 190 determines a computer vision mode or streaming mode when a camera is plugged into the connector 160. In another illustrative example, the processing system 190 determines an infrared mode when an infrared auxiliary component is plugged into the connector 160.

The processing system 190 can configured to: track measurement values over a time period. The measurement values can be stored onboard (e.g., in the memory of the processing system 190), stored remotely, and/or otherwise stored. The measurement values can be sampled from: a continuous insertion and/or temperature measurement, an intermittent insertion and/or temperature measurement, and/or otherwise sampled. The measurement values can be stored for: a cook session and/or a food instance, a predetermined timeframe, indefinitely, and/or for any other period of time. The cook session and/or the food instance can be: determined manually, determined by the cooking accessory 100, determined by an external system 300, and/or otherwise determined. In a first example, the cook session and/or food instance is determined by the cooking accessory 100 using heuristics. In a first specific example, the cook session instance is deemed the same cook session instance when successive temperature measurements are changing as expected (e.g., increasing temperature at a predetermined rate, decreasing temperature at a predetermined rate). In a second specific example, a different cook session instance is identified after a threshold time period (e.g., <1 hour, 1 hour, 2 hours, 3 hours, 4 hours, >4 hours, etc.). In a third specific example, a different cook session instance is identified when a thickness of the food is outside a predetermined range for the thickness of the food. In a second example, the cook session and/or food instance is determined by an external system 300 (e.g., a cooking appliance). In a first specific example, the external system 300 identifies a food and sends the food identifier associated with the food to the cooking accessory 100. In a second specific example, the external system 300 identifies a food instance and a cooking accessory 100 instance (e.g., based on a cooking accessory 100 identifier, such as a QR code or an NFC signature) and associates the food instance with the measurement (e.g., using the timestamp and concurrent identification).

The processing system 190 can be configured to: generate and/or present notifications. Notifications can be presented on: a display, an external display (e.g., user display, browser, etc.), a smart speaker, and/or any other suitable interface. Notifications can be: visual, audio, a video, haptic (e.g., vibration), and/or in any other suitable format. Notifications can be generated based on: an estimated time to completion, an internal temperature, a desired doneness, a food identifier, a timer, measurement of a target value (e.g., target temperature), and/or otherwise determined.

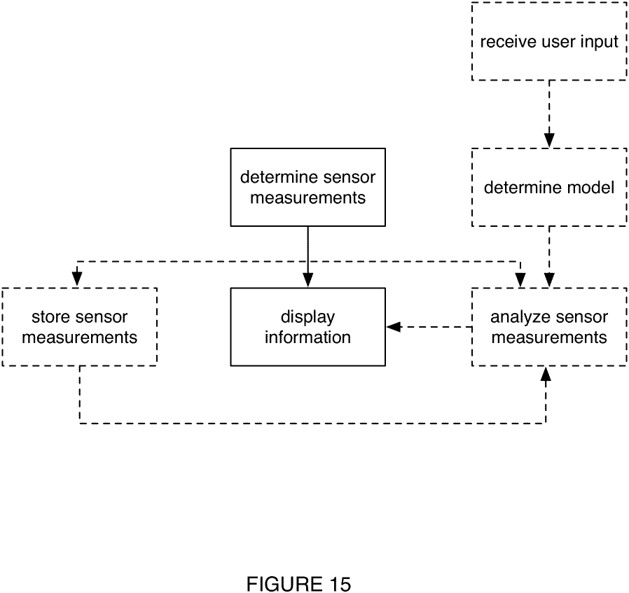

The processing system 190 can be configured to store and/or execute one or more models from a set of models. Models can be: a machine learning model (ML model), a classical model, an equation, a lookup table, a database, a predetermined series of measurements, a predetermined series of analyses or transformations, a neural network, leverage regression, classification, rules, heuristics, instance-based methods (e.g., nearest neighbor), regularization methods (e.g., ridge regression), decision trees, Bayesian methods (e.g., Naive Bayes, Markov, etc.), kernel methods, probability, deterministics, support vectors, and/or any other suitable model or methodology. Models can be generated onboard, generated remotely (e.g., by the remote computing system), programmed into the processing system 190, updated via firmware updates (e.g., received from a remote computing system, etc.), and/or otherwise determined. The models can be trained based on: data from external systems, measurements sampled by the cooking accessory (or another instance thereof), user-assigned labels, and/or any other suitable training data. The models can be executed onboard the processing system, remote from the cooking accessory (e.g., by the remote computing system), and/or by any other system. The model can be executed using: measurements from the cooking accessory’s sensors, measurements from auxiliary component, external data (e.g., from a database, from an external system, from a user device, etc.), and/or any other data. In variants, the system can: determine sensor measurements (e.g., from the cooking accessory), display information based on the sensor measurements, and optionally store the sensor measurements. The system can additionally or alternatively determine a model (e.g., based on a user input, such as a food identity selection) and analyze the sensor measurements (e.g., currently-measured sensor measurements, stored sensor measurements, etc.) using the model, wherein the displayed information can include the analysis result; an example is shown in FIG. 15.

In a first variant, a model can determine an estimated time to completion of a food. The estimated time to completion for a food can be determined using one or more methods, such as those described in U.S. Application No. 16/380,894 filed 10-APR-2019 and U.S. Application No. 17/100,046 filed 20-NOV-2020, both of which are incorporated in their entirety by this reference. For example, the cooking system can: determine a food identifier (e.g., manually entered, received from an external system 300 such as an oven, a phone, etc.); determine a target doneness (e.g., from user preferences stored in a remote computing system or in the processing system 190; manually entered; received from an external system 300; etc.); determine a cooking curve for the food; determine an estimated time to completion based on one or more recent temperature measurements and the cooking curve; and provide a final output based on the estimated time to completion (example shown in FIG. 16). The cooking curve can be: selected from a set of predetermined curves associated with a food identifier, based on a temperature measurement value or a timeseries thereof (e.g., the predetermined curve that best fits the temperature measurement values for the cooking session); calculated from the temperature measurement timeseries for the cooking session (e.g., a de novo curve that is fit to the timeseries); and/or otherwise determined. The cooking curve can describe the anticipated internal temperature progression for the food (e.g., the food class), or be otherwise constructed. When the cooking curve is selected from a curve set, the curve set can be associated with the food (e.g., food identifier, food class etc.), wherein each curve within the set can be associated with a different set of food parameter values (e.g., different food thicknesses, sizes, densities, preparations, etc.), or be otherwise defined. The estimated time to completion can be: a time difference between a current time associated with a current measurement value and a target time associated with a target measurement value (associated with target doneness level) on the cooking curve; a time difference between the current measurement value and the target time plus a resting time; a wall clock time equivalent to the current time plus the time difference; and/or otherwise determined. The final output can be: the estimated time to completion, a wall clock time for estimated cooking completion (e.g., the current wall clock time plus the estimated time to completion), a status associated with the time difference and/or measurement value (e.g., “not done,” “almost done,” “done,” etc.); and/or be any other output.

In a second variant, a model can automatically and/or manually identify a food. The model can: automatically identify a food via an external system 300 (e.g., via wireless or wired connection), automatically infer a food from sensor measurements, manually identify a food (e.g., received via user interface 150), and/or otherwise determined. The food identity can be inferred based on: the temperature change profile; images sampled by an auxiliary camera; the inferred food thickness (e.g., measured from temperature differences between temperature sensors in the temperature probe 120); the food density (e.g., sampled by the temperature probe during insertion); and/or any other information.

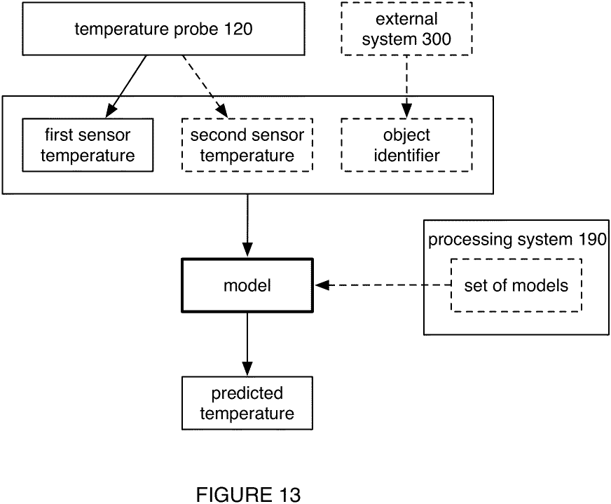

In a third variant, a model can generate a more accurate temperature estimate. For example, a model can aggregate (e.g., average, mean, median, etc.) concurrently-sampled temperature measurements from multiple temperature sensor (e.g., example shown in FIG. 13).

In a fourth variant, a model can determine whether a cooking cavity is open or closed. In this variant, the model can be trained on sensor measurements (e.g., temperature measurements) labeled with a cavity open/closed state.

However, any other suitable model can be generated and used (e.g., executed onboard the cooking accessory). Additionally or alternatively, the measurements can be transmitted to a remote computing system, wherein all or a portion of the models are executed by the remote computing system. The remote computing system can optionally return the model output to the cooking accessory and/or another user interface (e.g., user device).

The processing system 190 can be configured to: receive operating instructions from the cooking system (e.g., an operation mode selection, etc.). The processing system 190 can additionally or alternatively be configured to control the cooking system (e.g., based on the measurements, based on a set of control instructions received from an external system 300, etc.). For example, the processing system 190 can execute a program associated with a set of control instructions (e.g., user instructions). The program can include: instructions to execute one or more models (e.g., a single model, a series of models, etc.), a predetermined analysis, a predetermined series of measurements (e.g., from one or more connected sensors), a series of operation instructions (e.g., instructions to display a predetermined set of variables or visual assets, etc.), and/or any other program.

However, the processing system can be otherwise configured and/or perform any other functionality.

The cooking accessory 100 can be used with one or more auxiliary components 200, one or more external systems 300, and/or any other suitable system. The auxiliary components 200 are preferably removably connected to the cooking accessory 100, but can alternatively be permanently connected to the cooking accessory 100.

The auxiliary component 200 (e.g., external accessory) can be: a removable probe, a continuous-read thermometer (e.g., a wired probe), a thermocouple sensor, a camera (e.g., dedicated camera, camera of a user device, etc.), an infrared auxiliary component (e.g., with a thermophile, an infrared sensor, etc.), a speaker, an auxiliary display, an auxiliary user input (e.g., a keyboard, a mouse, a microphone, etc.), a humidity sensor, a moisture sensor, a pressure sensor, a scale, a flashlight, an auxiliary power source (e.g., external battery pack), a magnetic dock, a wearable belt, and/or any other suitable auxiliary components. The auxiliary component 200 preferably has a connector complimentary to the connector on the cooking accessory (e.g., male USB-C when the cooking accessory has a USB-C port), but can alternatively be wirelessly connected (e.g., paired) with the cooking accessory and/or otherwise connected to the cooking accessory. Each auxiliary component 200 can be identified by one or more auxiliary component identifiers (e.g., to enable the cooking accessory 100 and/or external system 300 to identify the auxiliary component 300), and/or otherwise identified. The auxiliary component identifier (e.g., auxiliary identifier, accessory identifier, external accessory identifier, etc.) can be: unique to the auxiliary component instance (e.g., globally unique), unique to the auxiliary component class (e.g., all removable probes or the same make or model share the same identifier), unique to the user, nonunique, and/or otherwise related to other auxiliary components. The auxiliary component identifier can be: an optical pattern (e.g., logo, barcode, QR code, etc.) printed feature, engraved, adhered, or otherwise coupled to the auxiliary component; an electromagnetic identifier (e.g., RF tag, NFC tag, etc.); a digital identifier (e.g., transmitted via the data connection provided by the connector); and/or any other suitable identifier. The auxiliary component 200 can power the cooking accessory 100, draw power from the cooking accessory 100, provide information to the cooking accessory 100, receive information to the cooking accessory 100, and/or otherwise used in relation to the cooking accessory 100.

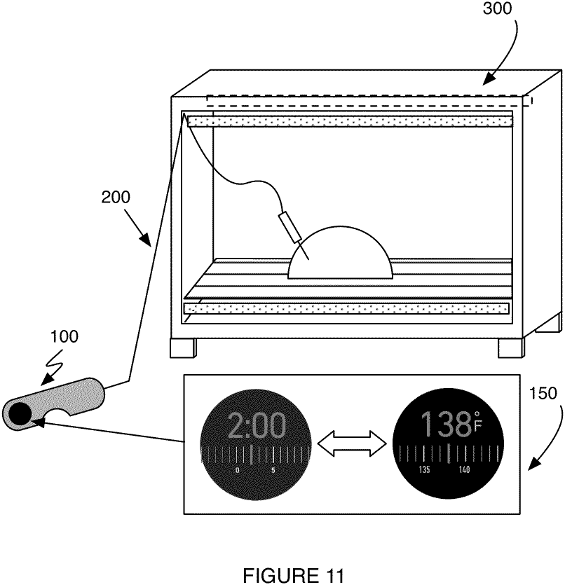

The infrared auxiliary component (example shown in FIG. 10) can includes: a housing and an infrared sensor. The housing is preferably thermally conductive, but can alternatively be thermally insulative. The thermally conductive housing can function as a heatsink for ambient heat (e.g., absorb ambient heat) and equilibrates the infrared sensor with the ambient environment. This can help correct for thermal effects, and can also provide a reference point for infrared measurement (e.g., used to filter out the ambient temperature from the sampled measurement, such that the measurement primarily represents the object’s infrared energy). However, the housing of the infrared auxiliary component can be otherwise used. The housing can define an inner bore, wherein the IR sensor is located within the inner bore. The inner bore can be: smooth, define baffles, and/or have any other feature. The features (e.g., bored) function to block in-housing noise and/or stray signals from entering the housing. The baffles can extend radially inward (e.g., perpendicular to the inner bore, at an angle to the inner bore, etc.) or be otherwise configured. The bores can extend along an arcuate subsection of the bore, extend arcuately along the circumference of the bore, spiral down the length of the bore, extend linearly along the length of the bore, and/or be otherwise configured. The baffles can be arranged between the housing inlet and the infrared sensor, and/or be otherwise arranged. The infrared sensor can be: a thermophile sensor, an infrared camera, an infrared LED, an infrared photodiode, and/or any other suitable infrared sensor. The infrared auxiliary component can have a 100:1 distance to spot ratio, 90:1 distance to spot ratio, 80:1 distance to spot ratio, 70:1 distance to spot ratio, 60:1 distance to spot ratio, 50:1 distance to spot ratio, 40:1 distance to spot ratio, 30:1 distance to spot ratio, 20:1 distance to spot ratio, 10:1 distance to spot ratio, and/or any other suitable ratio. However, the infrared auxiliary component can be otherwise configured.

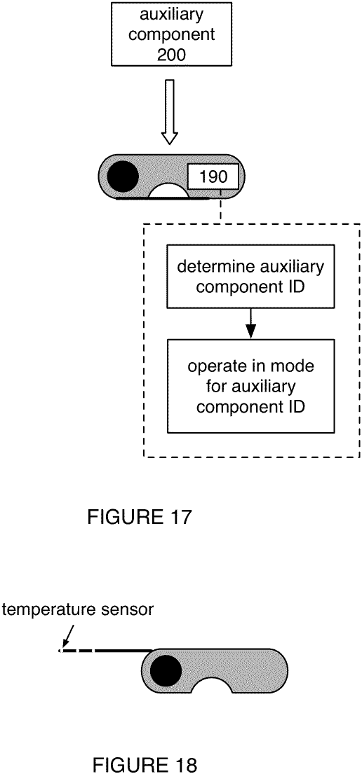

The auxiliary component 200 can add additional functionality to the cooking accessory 100, or not add additional functionality to the cooking accessory 100. The cooking accessory 100 can automatically identify the auxiliary component 200 (e.g., based on an auxiliary component identifier), automatically select an operation mode based on an auxiliary component identifier (e.g., example shown in FIG. 17), automatically interpret accessory measurements, and/or otherwise interact with the cooking accessory. In examples, a user can manually toggle between different sensing and/or output modes (e.g., associated with different connected auxiliary components) using the user interface.

In a first variant, an infrared auxiliary component can be connected to the cooking accessory 100 through a USB-C port to measure the surface temperature of an object (e.g., a pan, a stove, etc.). The cooking accessory 100 can detect that the infrared auxiliary component is connected, select an infrared mode, start recording infrared temperature measurements, and/or operate in the infrared mode. Examples of operating in the infrared mode can include: displaying an infrared image on the user interface or an external system (e.g., user device, cooking appliance, etc.); display an infrared icon on the user interface; display a minimum, maximum, average, and/or statistical measure of temperature derived from the infrared auxiliary component temperature measurements; display an instance of a temperature measurement from the infrared auxiliary component; and/or otherwise operate in the infrared mode.

In a second variant, a removable probe can be connected to the cooking accessory 100 through an auxiliary jack to measure the internal temperature of an object (e.g., a chicken, a steak, etc.); example shown in FIG. 11. The cooking accessory 100 can detect a connected removable probe, select a removable probe mode, and/or operate in the removable probe mode. Examples of operating in the removable probe mode can include: displaying the temperature measured by the removable probe (e.g., instead of or in addition to the temperature measured by the temperature probe); displaying an icon for the removable probe on the user interface; and/or otherwise operating in the removable probe mode.

However, the cooking accessory 100 can be otherwise used with an auxiliary component 200.

External systems 300 can be: a user device (e.g., a smartphone, a tablet, a laptop, etc.), a cooking appliance (e.g., oven, grill, smoker, sous-vide pot, refrigerator, etc.), a heated cook surface (e.g., a cooktop), a remote computing system, third party databases (e.g., recipe databases, weather databases, etc.), and/or any other suitable system.

In a first example, the external system 300 is a cooking appliance that includes: a cooking cavity, cooking elements operably connected to and/or mounted within the cooking cavity (e.g., heating elements, convection elements, steaming elements, smoking elements, etc.), and optionally sensing elements operably connected to and/or mounted within the cooking cavity (e.g., cameras, temperature sensors, humidity sensors, weight sensors, etc.). The cooking appliance is preferably a digitally controllable appliance, but can additionally or alternatively be a manually controlled appliance.

In a second example, the external system 300 is a remote computing system (e.g., platform) which functions to generate models, store models, update the cooking accessory 100 with models, store measurements of the cooking accessory 100, store user preferences, and route data between the cooking accessory 100 and other systems (e.g., other external systems). The remote computing system can be accessible via an API, through a unique endpoint, through a unique uniform resource identifier (URI), and/or otherwise accessed. Other external systems and/or the cooking accessory can connect to the remote computing system via Wi-Fi, Bluetooth (e.g., using a user device or other Bluetooth-connected hub as an access point), cellular, and/or any other suitable wireless communication, but can additionally and/or alternatively be accessible through a wired communication (e.g., Ethernet). The remote computing system can be: a cloud computing system, a distributed network, a server system, and/or any other computing system. The remote computing system can include: a model training system, a model repository, data storage, a device database, and/or any other suitable component.

In a third example, the external system 300 is a cooking appliance, such as that described in U.S. Application No. 16/793,368 filed 18-FEB-2020, which is incorporated in its entirety by this reference.

The cooking accessory 100 can be concurrently, contemporaneously, and/or asynchronously communicatively connected to one or more: wireless networks, external systems, and/or any other system.

In a first variant, the cooking accessory 100 is connected to a local network (e.g., Wi-Fi network), wherein the cooking accessory can communicate with external systems via the local network. In this variant, the cooking accessory can receive the local network credentials: from a user device, from the remote computing system, and/or from any other suitable system. In an illustrative example, the cooking accessory 100 is paired to a phone via Bluetooth through a companion app, wherein a user enters the Wi-Fi credentials on the companion app. The companion app and/or phone sends the Wi-Fi credentials to the communication module 130 of the cooking accessory 100, the communication module 130 stores the Wi-Fi credentials, and the cooking accessory 100 connects to LAN using the stored Wi-Fi credentials.

In a second variant, the cooking accessory 100 is connected to an external system via a wired connection (e.g., a data cable). However, the cooking accessory 100 can be otherwise connected to other systems.

The cooking accessory 100 can control the external system 300, or not control the external system 300. The cooking accessory can be controlled by the external system 300 (e.g., based on information received from the external system 300), or not be controlled by the external system 300.

In a first variant, the cooking accessory 100 can detect an external system state (e.g., cooking appliance door closed/open, cooking appliance on/off, etc.). The external system state can be determined based a timeseries of temperature measurements, based on a temperature measurement, and/or otherwise determined. In an example, the door of a cooking appliance is determined to be closed when the temperature measurement is increasing (e.g., from a constant heat source). In another example, the cooking appliance is determined to be off when the temperature measurement falls below a specified threshold and/or to ambient temperature.

In a second variant, the cooking accessory 100 can control an auxiliary system (e.g., fan, heating element, steam, smoke, etc.) of a cooking appliance. The auxiliary system of a cooking appliance can be controlled based on a cook session (e.g., cook program), based on instructions received from a different external system (e.g., remote computing system), and/or otherwise controlled. For example, the cooking accessory 100 can turn on and/or off specific heating elements of an oven.

In a third variant, the cooking accessory 100 can receive food parameters (e.g., food identifier, food doneness, target temperature, target cook time, etc.) from a user (e.g., from the user interface, a user device, etc.), wherein the cooking accessory 100 can: select an operation mode, interpret the measurements, and/or otherwise operate based on the food parameters. Additionally or alternatively, data associated with the cooking accessory measurements (e.g., sensor measurement values, notifications, timeseries, tables, etc.) can be sent to the user device for display, forwarding, storage, and/or other uses.

In a fourth variant, the cooking accessory 100 can receive and/or send information from and/or to a remote computing system (e.g., via the API, the unique URI, etc.). For example, the remote computing system can: receive cooking accessory information (e.g., measurements), run models based on cooking accessory measurements, update the models stored on the cooking accessory, update data stored on the cooking accessory, provide instructions to the cooking accessory (e.g., explicit operation instructions, reference to instruction set, etc.), and/or otherwise interact with the cooking accessory.

However, the cooking accessory 100 can be otherwise used with an external system 300.

In an illustrative example, the cooking accessory 100 can be a wirelessly-connected instant-read thermometer or a wirelessly-connected temperature probe (e.g., a handheld meat thermometer), and include a housing (e.g., plastic or metal housing), a temperature probe (e.g., linear probe with one or more sensors) mounted to the housing (e.g., rotatably or statically), and an onboard wireless chipset (e.g., configured to connect to a wireless network using stored wireless credentials, such as a WiFi network using a stored network name and password). The instant-read thermometer can optionally include: a display, physical user inputs (e.g., buttons), auxiliary connector ports (e.g., USB-C, auxiliary jack, etc.), a processor (e.g., configured to store and/or execute ML models stored on-board the cooking accessory 100), and/or other components.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. An instant-read thermometer, comprising:
• a housing;
• a temperature probe rotatably mounted to the housing about a rotational axis;
• a display mounted to the housing above the rotational axis; and
• a wireless module mounted within the housing, wherein the wireless module comprises a WiFi module, wherein the WiFi module is configured to connect to a WiFi network using a set of stored WiFi credentials.

2. The instant-read thermometer of claim 1, wherein the housing comprises a head, a base opposing the head, a back extending between the head and the base, and a front opposing the back, and wherein the wireless module comprises an antenna directed toward the front.

3. The instant-read thermometer of claim 1, further comprising:
• a data connector mounted to the housing; and
• an infrared accessory removably connected to the data connector.

4. The instant-read thermometer of claim 3, wherein the infrared accessory comprises a housing configured to absorb ambient heat.

5. The instant-read thermometer of claim 1, wherein the wireless module further comprises a Bluetooth module and is configured to receive the wireless credentials over a Bluetooth connection established between the Bluetooth module and an external user device.

6. The instant-read thermometer of claim 1, further comprising an onboard processing system mounted within the housing, wherein the processing system is configured to execute a set of models based on measurements sampled by the temperature probe.

7. The instant-thermometer of claim 6, wherein the set of models are received from a remote computing system.

8. The instant-read thermometer of claim 6, wherein the set of models comprise a model that estimates an amount of time until a monitored food reaches a target temperature, based on measurements of the monitored food sampled by the temperature probe.

9. A cooking accessory, comprising:
• a housing;
• a temperature probe mounted to the housing; and
• a WiFi module mounted within the housing and configured to connect to a WiFi network using a set of stored wireless credentials.

10. The cooking accessory of claim 9, wherein the temperature probe is actuatably mounted to the housing.

11. The cooking accessory of claim 10, wherein the housing defines a head, the cooking accessory further comprising:
• a probe hub rotatably mounted to the head and defining a hub rotational axis; and
• a display mounted to the head, wherein the hub rotational axis intersects the display.

12. The cooking accessory of claim 9, further comprising a connector mounted to the housing and configured to removably connect an external accessory, comprising at least one of an infrared sensor, a wired temperature probe, or a camera, to the cooking accessory.

13. The cooking accessory of claim 12, wherein the processing system receives an external accessory identifier for the external accessory connected to the connector and determines an operation mode based on the external accessory identifier.

14. The cooking accessory of claim 9, further comprising a processing system mounted within the housing, wherein the processing system is configured to execute a set of models based on measurements sampled by the temperature probe.

15. The cooking accessory of claim 14, wherein the set of models comprise machine learning models.

16. The cooking accessory of claim 14, wherein the processing system is configured to:
• determine a food identifier and a desired doneness level for a food;
• estimate a time to cooking completion based on temperatures measured by the temperature probe, a set of internal temperature cooking curves associated with the food identifier, and a target internal temperature associated with the desired doneness level; and
• display the time to cooking completion on the display.

17. The cooking accessory of claim 16, wherein at least one of the food identifier and the desired doneness level is received via a set of user inputs mounted to the housing.

18. The cooking accessory of claim 9, wherein the processing system is communicably coupled to an external system through a wireless module, wherein the wireless module comprises the WiFi module, wherein the processing system is further configured to:
• receive operating instructions identifying a cook session from the external system, wherein the cook session comprises a food identifier; and
• operate the cooking accessory based on the identified cook session.

19. The cooking accessory of claim 9, further comprising a Bluetooth module, wherein wireless credentials are received via the Bluetooth module.

20. The cooking accessory of claim 9, wherein the temperature probe extends from the housing, lacks an external wire, is partially enclosed within the housing.
